(19) United States
(12) Patent Application Publication
(10) Pub. No.: US 2023/0361878 A1
(43) Pub. Date: Nov. 9, 2023

(54) SYSTEMS AND METHODS FOR INCREASING AVAILABILITY IN OPTICAL NETWORKS

(71) Applicant: Corning Research & Development Corporation, Corning, NY (US)

(72) Inventors: Martin Hempstead, Painted Post, NY (US); Andreas Matiss, Berlin (DE); Martin Spreemann, Berlin (DE); Eric Stephan ten Have, Berlin (DE); Peter Gerard Wigley, Corning, NY (US)

(21) Appl. No.: 18/141,509

(22) Filed: May 1, 2023

Related U.S. Application Data
(60) Provisional application No. 63/338,475, filed on May 5, 2022.

(51) Int. Cl. H04B 10/294; H04B 10/112; H04J 14/02

(52) U.S. Cl. CPC H04B 10/294; H04B 10/1127; H04J 14/02

(57) ABSTRACT

Network access devices and methods for increasing availability in an optical network. The network access device includes a first common port configured to receive a primary optical beam, a second common port configured to receive a secondary optical beam, a wavelength division multiplexing device, and an optical coupling device. When operating in a normal state, the optical coupling device provides at least a portion of the primary optical beam to the wavelength division multiplexing device. In response to a problem being detected in the primary distribution cable, the optical coupling device provides at least a portion of the secondary optical beam to the wavelength division multiplexing device. Problems in the primary distribution cable may be detected by a sensing device in the network access device based on a loss of signal at the first common port.

### PRIORITY APPLICATION

This application claims the benefit of priority of U.S. Provisional Application No. 63/338,475, filed on May 5, 2022, the content of which is relied upon and incorporated herein by reference in its entirety.

### TECHNICAL FIELD

This disclosure relates generally to optical wavelength multiplexing, and more particularly to wavelength division multiplexing devices that improve network availability.

### BACKGROUND

As use of the Internet continues to grow, optical communication systems are being required to carry ever larger amounts of data. In the access portion of the network, the density and frequency of transactions are also increasing the value of the data traffic over time. In particular, the emergence of fifth generation (5G) cellular networks has increased the demand for high-bandwidth data transmission to service the numerous cell sites and other nodes of the radio access network (RAN). The demand for front, mid, and back-hauling services by 5G RANs are driving demand for both higher data capacity and guaranteed availability levels. The reliance on networks for conducting business by way of video conferences and large file transfers from remote locations is also increasing demand for fiber to the x (FTTX) services that have guaranteed availability levels. Carriers cannot provide network availability levels sufficient to support the service level agreements (SLAs) being demanded based on currently deployed architectures, equipment, and processes. End users and vendors also lack cost effective solutions that could deliver the availability demanded by these large data capacity applications.

Field service test equipment, traditionally used to assure build quality before release into the network, cannot assure service quality in real time. End users are thus evaluating embedded network monitoring and preventative maintenance solutions in order to compete in a service level-based market. Accordingly, network carriers are being forced to upgrade their networks to enable compliance with SLAs that guarantee higher availability in the optical distribution portion of their networks, to support 5G key performance indicators, and to meet their client's availability goals.

In most cases, existing optical distribution networks can only provide three nines (99.9%) availability. However, the required availability in radio access networks and other critical infrastructure is typically four or five nines (99.99% or 99.999%) availability. To meet three nines availability, a network can only be unavailable for a total of nine hours a year. Four nines availability guarantees reduce the allowable downtime to 52 minutes a year. An SLA promising five nines availability is violated if the network is down for more than a total of five minutes in the span of a year.

The trend is for convergence of access networks so that network infrastructure is shared between RAN and FTTX services. A fiber break or other interruption along a fiber optic feeder or distribution cable can thus potentially affect multiple services. In order to restore these services quickly enough to avoid violating SLAs, the network must reroute affected traffic via an alternative path. This is currently accomplished by electrically switching and routing traffic signals in every node of the electrical portion of the network to switch traffic signals via alternative nodes.

However, providing an alternative path through electrical switching in each node is not practicable for optical networks in which multiple services coexist. This is largely because there is often only one optical path between the head-end and the network access point to which a network node that lost service is connected. To provide required service availability at these network nodes, the optical distribution network must include at least one independent direct optical link between the nodes in a network that provides an alternative to the primary path. This alternative path is commonly called a protection path. If data transmitted over the primary path does not arrive at the network node, the head-end switches transmission to the protection path.

For total protection, complete redundancy is required. Thus, the protection path must include not only the optical fiber, but also the transmitters and receivers at each end of the optical fiber. Such an arrangement is costly, particularly for WDM systems since multiple transmitters are required for each path. In cases where the degree of protection assured by full redundancy is not needed, transmitters can be switched between the primary and protection optical fibers. However, in order to switch the transmitters, information about a failure in the primary path must be obtained and relayed to the switch controller, which adds considerably to the complexity of the protection system. Thus, there is a need in fiber optic networks for improved devices and methods for increasing the availability of the network.

### SUMMARY

In an aspect of the disclosure, a network access point is provided. The network access point includes a first common port configured to receive a primary optical beam including a plurality of primary optical signals, a second common port configured to receive a secondary optical beam including a plurality of secondary optical signals, a wavelength division multiplexing device including a plurality of channel ports each configured to transmit a respective optical signal of a selected one of the plurality of primary optical signals or the plurality of secondary optical signals, and an optical coupling device configured to operatively couple at least one of the primary optical beam and the secondary optical beam to the wavelength division multiplexing device.

In an embodiment of the disclosed network access point, the optical coupling device may include a beam splitter configured to split each of the primary optical beam and the secondary optical beam into a first portion thereof and a second portion thereof, and the first portion of each of the primary optical beam and the secondary optical beam may be provided to the wavelength division multiplexing device.

In another embodiment of the disclosed network access point, the network access point may further comprise a tap port, and the second portion of each of the primary optical beam and the secondary optical beam may be provided to the tap port.

In another embodiment of the disclosed network access point, the beam splitter may be further configured to split an uplink optical beam into a first portion thereof and a second portion thereof, provide the first portion of the uplink optical beam to the first common port, and provide the second portion of the uplink optical beam to the second common port.

In another embodiment of the disclosed network access point, the optical coupling device may include an optical switch having a first switch state and a second switch state. While in the first switch state, the optical switch may operatively couple the first common port to the wavelength division multiplexing device and optically isolate the second common port from the wavelength division multiplexing device. While in the second switch state, the optical switch may operatively couple the second common port to the wavelength division multiplexing device and optically isolate the first common port from the wavelength division multiplexing device.

In another embodiment of the disclosed network access point, the network access point may further include an actuator and a sensing device. The actuator may be configured to switch the optical switch from the first switch state to the second switch state in response to receiving a trigger signal. The sensing device may be configured to generate the trigger signal in response to detecting one or both of a loss of signal at the first common port and a presence of signal on the second common port.

In another embodiment of the disclosed network access point, the sensing device may be further configured to detect a presence of signal at the first common port, and the actuator may be further configured to cause the optical coupling device to operatively couple the wavelength division multiplexing device to the first common port in response to the sensing device detecting the presence of signal at the first common port.

In another embodiment of the disclosed network access point, the actuator may include a first actuator state that causes the optical switch to be in the first switch state, a second actuator state that causes the optical switch to be in the second switch state, and a latching device configured to maintain the actuator in the first actuator state until the trigger signal is received from the sensing device.

In another embodiment of the disclosed network access point, the latching device may be further configured to release the actuator in response to receiving the trigger signal while the actuator is in the first actuator state, and in response to the actuator entering the second actuator state, maintain the actuator in the second actuator state until the actuator is reset.

In another embodiment of the disclosed network access point, the network access point may further include a first auxiliary port, and the optical switch may be further configured to operatively couple the first auxiliary port to the second common port while in the first switch state.

In another embodiment of the disclosed network access point, the network access point may include a second auxiliary port, and the optical switch may be further configured to operatively couple the second auxiliary port to the first common port while in the second switch state.

In another aspect of the disclosure, a method of increasing availability in an optical network is disclosed. The method includes transmitting the primary optical beam including the plurality of primary optical signals over the primary distribution cable to the first common port of the network access point, splitting the primary optical beam into the first portion thereof and the second portion thereof at the network access point, and providing the first portion of the primary optical beam to the wavelength division multiplexing device of the network access point. In response to detecting a problem in the primary distribution cable, the method stops transmitting the primary optical beam over the primary distribution cable and begins transmitting the secondary optical beam including the plurality of secondary optical signals over the secondary distribution cable to the second common port of the network access point. The method further includes splitting the secondary optical beam into the first portion thereof and the second portion thereof at the network access point, and providing the first portion of the secondary optical beam to the wavelength division multiplexing device of the network access point.

In an embodiment of the disclosed method, the method may further include providing the second portion of the primary optical beam or the second portion of the secondary optical beam to the tap port of the network access point.

In another embodiment of the disclosed method, the method may further include splitting the uplink optical beam into the first portion thereof and the second portion thereof at the network access point, providing the first portion of the uplink optical beam to the first common port, and providing the second portion of the uplink optical beam to the second common port.

In another aspect of the disclosure, another method of increasing service availability in an optical network is disclosed. The method includes transmitting the primary optical beam including the plurality of primary optical signals over the primary distribution cable to the first common port of the network access point, transmitting the secondary optical beam including the plurality of secondary optical signals over the secondary distribution cable to the second common port of the network access point, and operatively coupling the primary optical beam from the first common port of the network access point to the wavelength division multiplexing device of the network access point. In response to detecting the problem in the primary distribution cable, the method operatively couples the secondary optical beam from the second common port of the network access point to the wavelength division multiplexing device of the network access point.

In an embodiment of the disclosed method, the secondary optical beam may be transmitted over the secondary distribution cable in response to detecting the problem with the primary distribution cable.

In another embodiment of the disclosed method, the problem in the primary distribution cable may be detected based at least in part on the loss of signal at the first common port of the network access point.

In another embodiment of the disclosed method, the problem in the primary distribution cable may be detected based at least in part on a presence of signal at the second common port of the network access point.

In another embodiment of the disclosed method, the method may further include, in response to detecting a presence of signal at the first common port of the network access point while the second common port is operatively coupled to the wavelength division multiplexing device, optically coupling the first common port to the wavelength division multiplexing device and optically isolating the second common port from the wavelength division multiplexing device.

In another embodiment of the disclosed method, the method may further include, while the primary optical beam is operatively coupled from the first common port to the wavelength division multiplexing device, operatively coupling the second common port to the first auxiliary port, and in response to detecting the problem in the primary distribution cable, operatively coupling the first common port to the second auxiliary port of the network access point.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIGS. 1A-1C are schematic views of exemplary protection schemes, each including a head-end node operatively coupled to a network access point by primary and secondary distribution cables;

FIGS. 2A-2C are schematic views of an exemplary network access point which may be used in the exemplary protection schemes of FIGS. 1A-1C;

FIGS. 3A and 3B are schematic views of another exemplary network access point which may be used in the exemplary protection schemes of FIGS. 1A-1C;

FIGS. 4A and 4B are schematic views of yet another exemplary network access point which may be used in the exemplary protection schemes of FIGS. 1A-1C;

FIG. 5 is a schematic view of the head-end node of FIGS. 1B and 1C operatively coupled to an exemplary optical coupling device;

FIG. 6 is a schematic view of the network access point of FIGS. 1A-1C including the exemplary optical coupling device of FIG. 5;

FIG. 7 is a schematic view of an optical coupling device which may be used in the exemplary protection schemes of FIGS. 1A-1C and network access points of FIGS. 2A-4B; and

FIGS. 8A and 8B are schematic views of the optical coupling device of FIG. 7 depicting different operating states thereof.

### DETAILED DESCRIPTION

Various embodiments will be further clarified by examples in the description below. In general, the description relates to providing end-to-end protection in an optical network using wavelength division multiplexing (WDM). Protection schemes may include a network access point having one common port that is coupled to the optical network by a primary distribution cable and another common port that is coupled to the optical network by a secondary distribution cable. The network access point includes both WDM and optical coupling features that operatively couple one or more optical signals between the primary distribution cable and one or more drop cables when the network is operating in a normal state, and that operatively couple one or more optical signals between the secondary distribution cable and the one or more drop cables when the network is operating in a protection state. In this way, the network access device may minimize any interruption in optical communication between tail-end nodes connected to the drop cables and one or more head-end nodes that provide optical signals to, and receive optical signals from, one or both of the primary and secondary distribution cables.

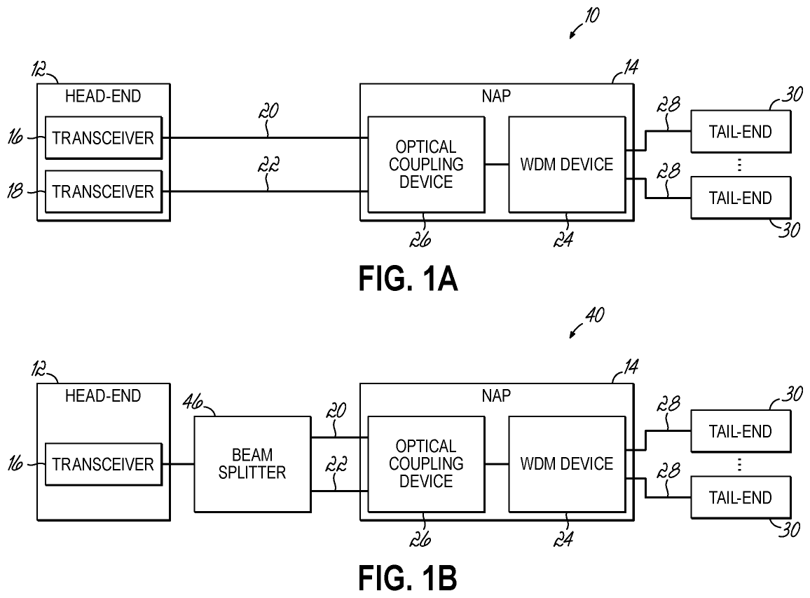

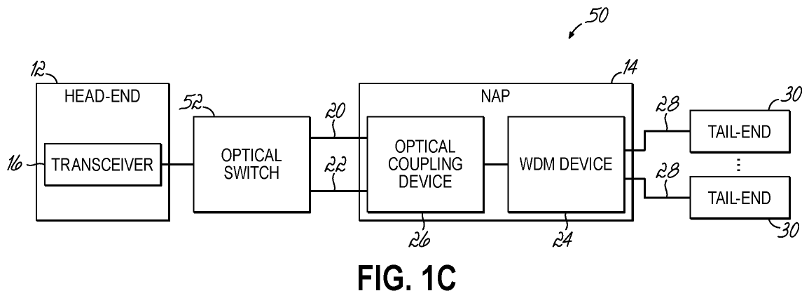

FIG. 1A depicts an exemplary protection scheme 10 that includes a head-end node 12 and a network access point (NAP) 14. The head-end node 12 includes a primary transceiver 16 and a secondary transceiver 18. The primary transceiver 16 is operatively coupled to the network access point 14 by a primary distribution cable 20, and the secondary transceiver 18 is operatively coupled to the network access point 14 by a secondary distribution cable 22. The primary transceiver 16 may provide one or more optical signals to, and receive one or more optical signals from, the primary distribution cable 20. The secondary transceiver 18 may provide one or more optical signals to, and receive one or more optical signals from, the secondary distribution cable 22. Each of the primary and secondary transceivers 16, 18 may transmit an optical beam that is a duplicate of the optical beam being transmitted by the other transceiver 16, 18 so that the same information is transmitted to the network access point 14 on each distribution cable 20, 22. As used herein, the term “optical beam” is not limited to light propagating through free-space, and may also be used to broadly refer to light propagating through optical waveguides or through any other suitable devices or mediums.

The network access point 14 includes a WDM device 24 and optical coupling device 26 (e.g., an optical switch or beam splitter) that operatively couples the WDM device 24 to the primary and secondary distribution cables 20, 22. For protection schemes in which an optical beam may be transmitted simultaneously on each of the primary and secondary distribution cables 20, 22, the optical coupling device 26 may include an optical switch. The optical switch may be provided by any suitable device that selectively optically couples one of the primary and secondary distribution cables 20, 22 to the WDM device 24 while isolating the WDM device 24 from the other of the primary and secondary distribution cables 20, 22. When optical beams are being transmitted simultaneously through both the primary and secondary distribution cables, the secondary optical beam may be redundant to (i.e., a duplicate of) the primary optical beam. In other cases, the secondary optical beam may carry low-priority data traffic while the network is operating in the normal state. In this case, the low-priority data may be dropped and replaced with the data traffic previously carried by the primary optical beam in response to the network entering the protection state.

The WDM device 24 may be configured to split the optical beam received from the optical coupling device 26 into individual optical signals that are operatively coupled into respective drop cables 28. Each drop cable 28 may operatively couple the optical signal received from the WDM device 24 to a respective tail-end node 30, and operatively couple an optical signal received from the respective tail-end node 30 to the WDM device 24. The WDM device 24 may combine the individual optical signals received from each drop cable 28 into one optical beam and provide this optical beam to the optical coupling device 26. The optical coupling device 26 may, in turn, couple the combined optical beam received from the WDM device 24 into one or more of the distribution cables 20, 22 for transmission to the head-end node 12.

Each tail-end node 30 may include a network interface device (NID), optical network terminal (ONT), or other device that receives the optical signal and converts it to an electrical signal (e.g., TCP/IP over Ethernet) suitable for use by one or more devices at the end point (e.g., switches, routers, computers, cellular transceivers, etc.). Each tail-end node 30 may also generate an optical signal that carries data received by the tail-end node 30 from the end point devices for transmission over the drop cable 28 to the network access point 14.

FIG. 1B depicts another exemplary protection scheme 40 that includes the head-end node 12 with a single (e.g., primary) transceiver 16 coupled to each of the primary and secondary distribution cables 20, 22 by a beam splitter 46. Operation of the depicted protection scheme 40 may be similar to that described above with respect to the protection scheme 10 of FIG. 1A. However, the optical beam on each of the primary and secondary distribution cables 20, 22 may have about half of the total output power of the transceiver 16, and the secondary distribution cable 22 may be unable to carry low-priority data traffic while the network is operating in the normal state. In addition, the depicted protection scheme 40 of FIG. 1B may be unable to maintain availability of optical signals at the tail-end nodes 30 if the transceiver 16 malfunctions.

FIG. 1C depicts yet another exemplary protection scheme 50 that includes the head-end node 12 with its transceiver 16 coupled to each of the primary and secondary distribution cables 20, 22 by an optical switch 52. The optical switch 52 may be configured to selectively couple the transceiver 16 to the primary distribution cable 20 under normal conditions. In response to detecting a problem with the primary distribution cable 20 (e.g., a high level of reflected optical signals indicative of a severed connection), the state of the optical switch 52 may be changed so that the transceiver 16 is operatively coupled to the secondary distribution cable 22. Operation of the depicted protection scheme 50 may be similar to that described above with respect to the protection schemes 10, 40 of FIGS. 1A and 1B. However, switching the output of the transceiver 16 such that the inactive distribution cable 20, 22 is dark may allow use of a passive beam splitter in the optical coupling device 26 of network access point 14.

For purposes of clarity, the above descriptions of FIGS. 1A-1C are focused on downlink optical beams transmitted from the head-end node 12 to the network access point 14. However, it should be understood that the network access point 14 may also transmit one or more uplink optical beams to the head-end node 12 through one or more of the primary and secondary distribution cables 20, 22. Advantageously, the optical coupling device 26 may enable each of the distribution cables 20, 22 to be operated in a full duplex mode in which optical beams are transmitted in both uplink and downlink directions on one or both distribution cables 20, 22. The optical coupling device 26 may also enable the distribution cables 20, 22 to be operated in a collective duplex mode in which an uplink optical beam is transmitted on one of the distribution cables 20, 22 and a downlink optical beam transmitted on the other of the distribution cables 20, 22.

Architectures containing redundant optical paths such as depicted in FIGS. 1A-1C are protected because there is a secondary path that supports traffic in the event of a failure in the primary path. To be fully protected, the secondary path may provide equivalent capacity and quality of service to the primary path. That is, the secondary path may be reserved for use as a protection path. However, as described above, other protection schemes may allow the secondary optical path to be used for lower priority “extra traffic” when the network is operating in the normal state. In the event of a primary path failure, the extra traffic may be dumped in favor of restoring capacity for priority traffic. Protection of specific network paths may be applied selectively to more vulnerable network segments within protection domains, and more frequently in cases where there is a demand for high service levels.

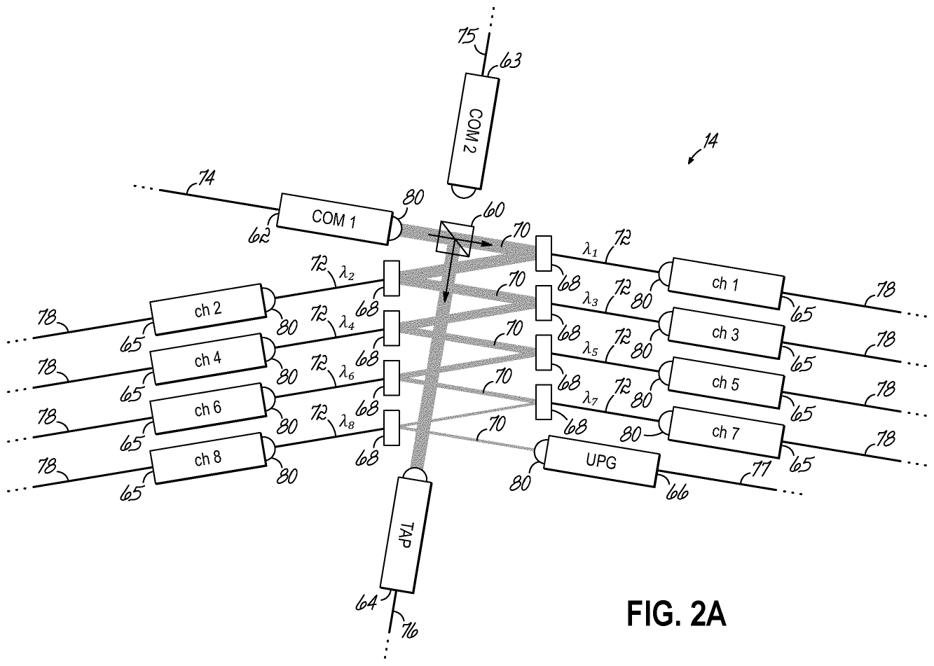

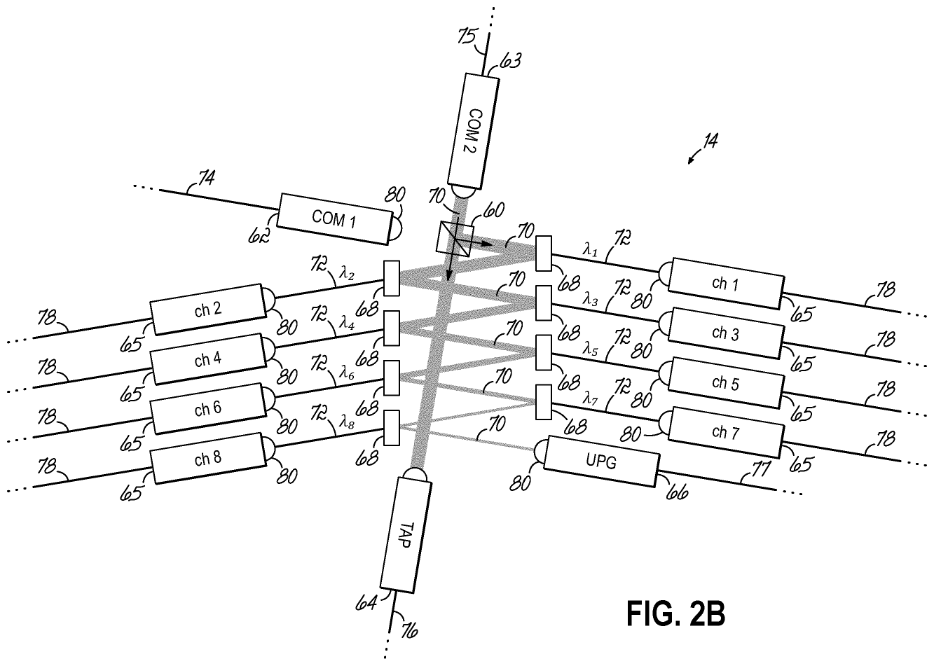

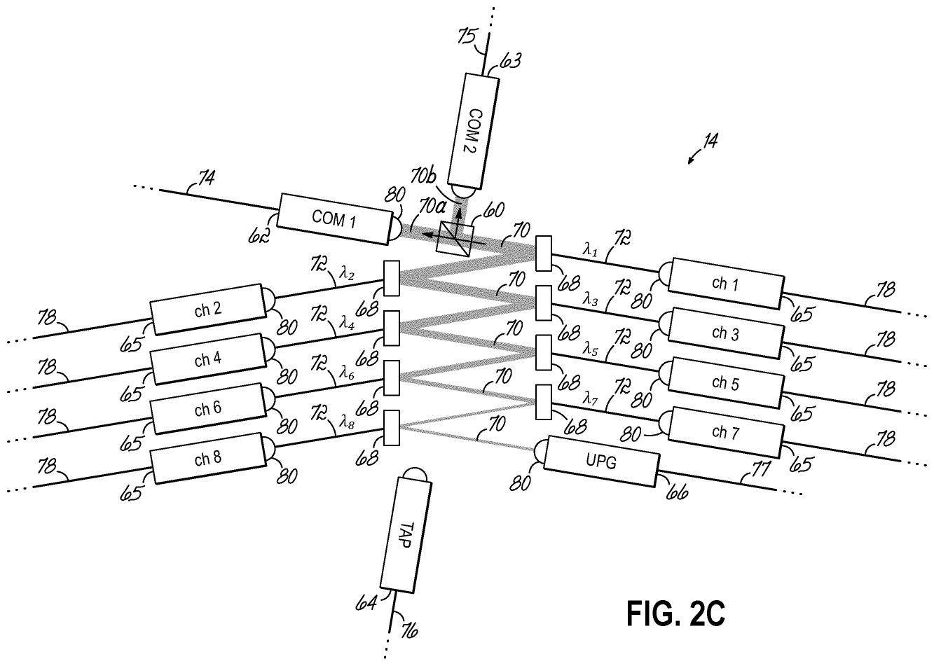

FIGS. 2A-2C depict an exemplary network access point 14 that includes a beam splitter 60, a primary common port 62, a secondary common port 63, a tap port 64, a plurality of (e.g., 8) channel ports 65, an upgrade port 66, and a plurality of (e.g., 8) bandpass filters 68. The beam splitter 60 may be a non-polarizing beam splitter configured to alternately receive an optical beam 70 from one of the primary common port 62 (FIG. 2A) or the secondary common port 63 (FIG. 2B), and split the optical beam 70 into a transmitted portion and a reflected portion. As best depicted by FIG. 2C, the beam splitter 60 may also receive an optical beam 70 from the bandpass filters 68. This uplink optical beam 70 may be split by the beam splitter 60 into a transmitted portion 70a that is provided to the primary common port 62, and a reflected portion 70b that is provided to the secondary common port 63. Advantageously, the beam splitter 60 may thereby provide redundant uplink optical beams to the network.

In the depicted embodiment, the transmitted portion of the optical beam 70 emitted by the primary common port 62 propagates toward the filters 68, and the reflected portion of the optical beam 70 emitted by the primary common port 62 propagates toward the tap port 64. Conversely, the transmitted portion of the downlink optical beam 70 emitted by the secondary common port 63 propagates toward the tap port 64, and the reflected portion of the optical beam 70 emitted by the secondary common port 63 propagates toward the filters 68.

The beam splitter 60 may include a pair of cemented prisms, a half-silvered mirror, a polarizing beam splitter, or any other suitable optical device. The beam splitter 60 may be configured to split the optical beam so that each of the transmitted and reflected portions includes about 50% of the incident beam, i.e., the beam splitter 60 may be a symmetric beam-splitter. However, it should be understood that embodiments of the network access point 14 are not limited to any specific beam splitting ratio, and non-symmetric beam-splitters may also be used.

The filters 68 may be arranged to sequentially receive the optical beam 70 and selectively pass an optical signal 72 embedded in the optical beam 70. Each optical port 62-66 may be configured to receive an optical fiber 74-78 and include a collimator 80 configured to optically couple a respective optical signal 72 to and from (i.e., between) the optical fiber 74-78 and its respective filter 68. Each filter 68 may be configured to transmit optical signals 72 having a wavelength λₙ within the range of wavelengths covered by the passband of the filter 68 and reflect other optical signals 72 having wavelengths λₙ outside the range of wavelengths covered by the passband of the filter 68.

Each filter 68 may separate out or add one or more optical signals 72 to the optical beam 70 depending on the wavelength of the optical signal 72 and direction in which the optical signal 72 is travelling. The filters 68 may thereby provide a WDM device that bi-directionally separates optical signals 72 received from the optical fiber 74, 75 at one of the primary or secondary common ports 62, 63, and combines optical signals 72 received from channel ports 65 for transmission into the optical fiber 74, 75 connected to the primary and secondary common ports 62, 63.

Although FIGS. 2A-2C depict the WDM device of the network access point 14 as being a free-space compact module, embodiments of the network access point 14 are not limited to this type of WDM device. Thus, it should be understood that the WDM device 24 of FIGS. 2A-2C may comprise other types of optical devices that separate and combine the optical signals 72. These devices may include, for example, a fully fiber based device using channel three ports and one fiber based splitter (e.g., having a 1:1 or any other desired ratio), as well as devices based on arrayed waveguide gratings, optical add-drop multiplexers, prisms, or the like.

The network access point 14 depicted by FIGS. 2A-2C is only one possible implementation and relies on a beam splitter 60 that provides an “always ready” redundant secondary common port 63. The direction of the split beam may be to the side (i.e., in plane—as shown) or vertical (i.e., out of plane). Vertical splitting may be used, for example, in a multi-layer (e.g., two-layer) configuration. The use of a beam splitter may result in additional signal losses in each of the common port to channel port links, depending on the beam splitting ratio. The portion of the optical beam 70 which is directed away from the plurality of filters 68 may be discarded or coupled to the tap port 64 as shown. Coupling a portion of the optical beam to the tap port 64 may allow the tap port 64 to be used as an upgrade port for cascading multiple devices or as a tap port for network monitoring purposes.

A potential use for the secondary common port 63 may include splitting power equally in a “bridge and select” architecture that provides a redundant protection path in the network. This type of architecture may be enabled by transmitting a portion of the optical beam received at the primary common port 62 from the secondary common port 63 with a loss of 3 dB to provide a path back to a head-end node 12 that contains either a secondary transceiver 18 (FIG. 1A) or an optical switch 52 (FIG. 1C).

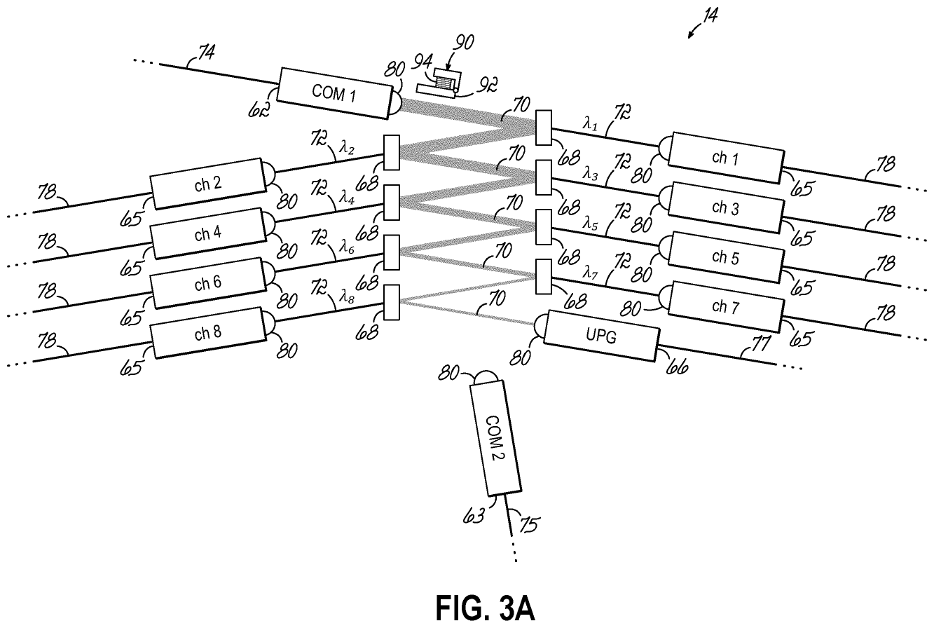

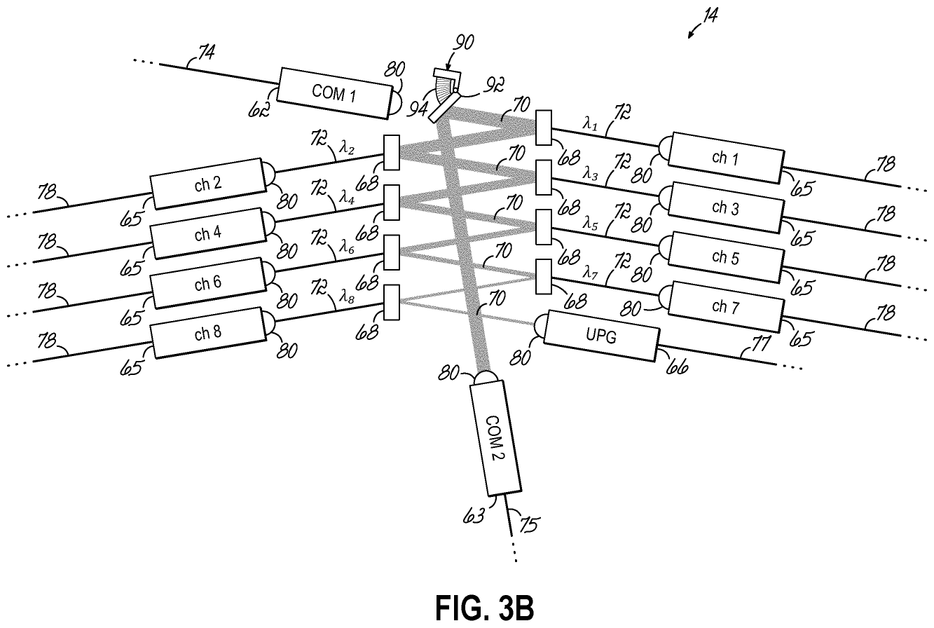

FIGS. 3A and 3B depict another exemplary network access point 14 including an optical switch 90. The optical switch 90 includes a reflector 92 and a positioning device 94 configured to selectively position the reflector 92 in either a primary position or a secondary position. FIG. 3A depicts the optical switch 90 in a primary state in which the reflector 92 is positioned in a primary position that is outside the path of the optical beam 70. FIG. 3B depicts the optical switch 90 in a secondary state in which the reflector 92 is positioned in a secondary position that is in the path of the optical beam 70. The primary common port 62, secondary common port 63, and optical switch 90 may be configured so that when the reflector 92 is in the primary position, an optical beam 70 emitted by the primary common port 62 is received by the filters 68, and when the reflector 92 is in the secondary position, an optical beam 70 emitted by the secondary common port 63 is received by the filters 68.

The reflector 92 may include a mirror, a prism, or any other suitable optical device that reflects or otherwise alters the path of the optical beam 70. The positioning device 94 may include an electro-optical or electro-mechanical device that selectively positions the reflector 92 in or out of the path of the optical beam 70. Technologies which may be used for the positioning device 94 may include, but are not limited to, Micro-Electro-Mechanical Systems (MEMS) and macroscopic electromagnetic relays. These technologies may also allow for latching devices that only require energy during the switching event, e.g., moving the reflector 92 from the primary position to the secondary position, or from the secondary position to the primary position. Insertion of the reflector 92 into the path of the optical beam 70 may be from the side, top, or bottom, and the switching process may be triggered by detecting one or both of a loss of signal or a presence of signal at a tap port or other suitable location. Loss of signal may be defined as a condition under which the amount of optical energy at a port is below a predetermined loss of signal threshold. Presence of signal may be defined as a condition under which the optical energy at a port is above a presence of signal threshold. These conditions may also be determined based on the amount of bit errors in a received signal, or any other metric indicative of the presence or absence of a usable optical signal.

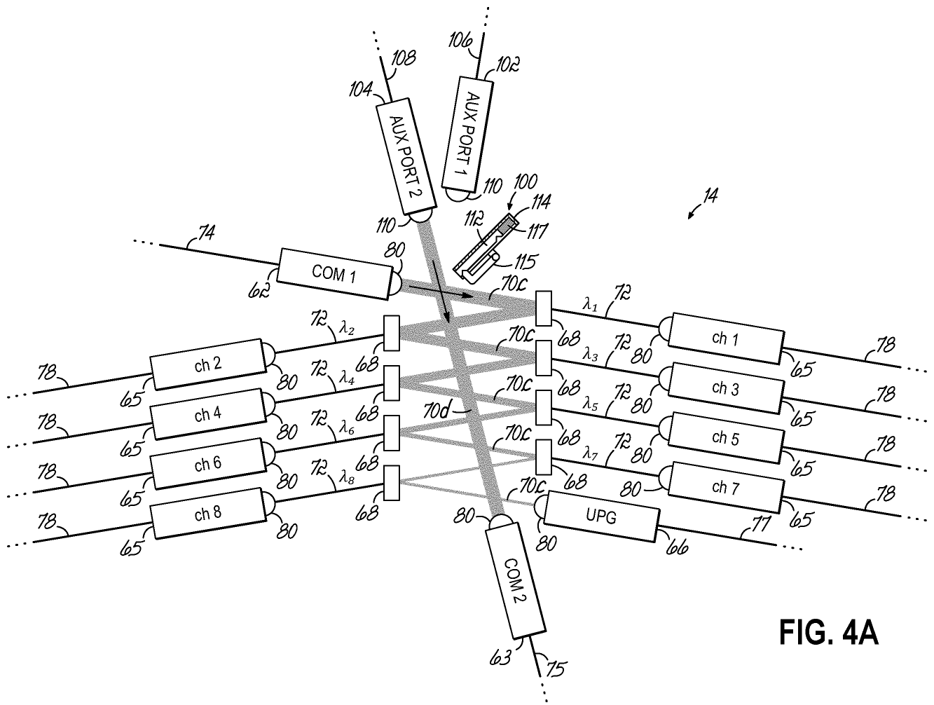

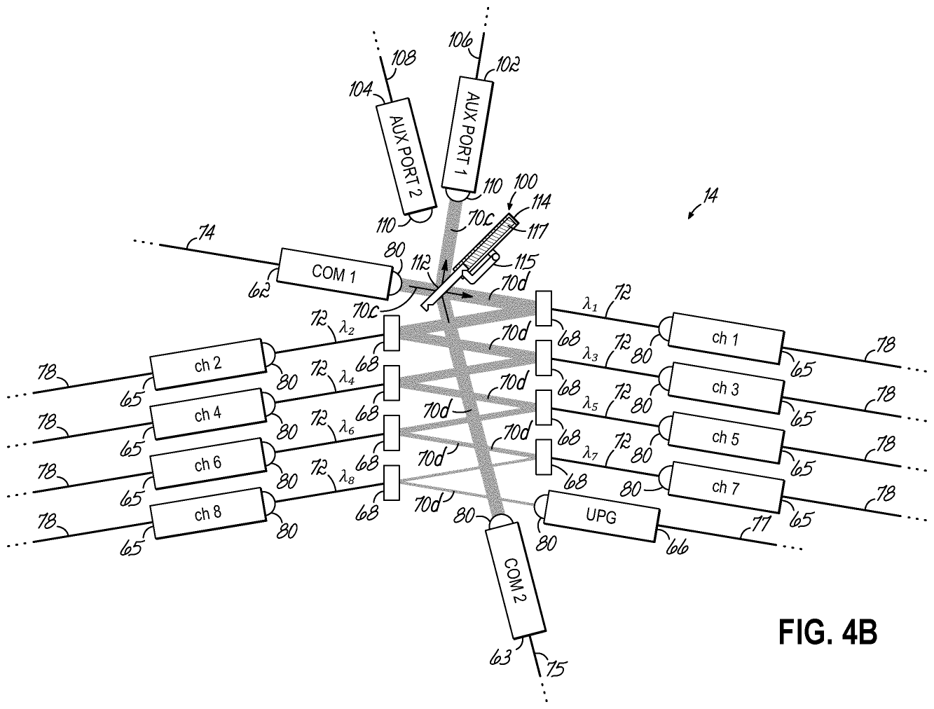

FIGS. 4A and 4B depict yet another exemplary network access point 14 in which the non-active common ports are operatively coupled to respective auxiliary ports. The network access point 14 includes an optical switch 100, a primary auxiliary port 102, and a secondary auxiliary port 104. Each of the auxiliary ports 102, 104 may be configured to receive a respective optical fiber 106, 108 and include a collimator 110. In the depicted embodiment, the primary common port 62 is shown emitting/receiving a primary optical beam 70c, and the secondary common port 63 is shown emitting/receiving a secondary optical beam 70d.

The optical switch 100 may include a reflector 112 and a positioning device 114. The positioning device 114 may include a latching device 115 and an actuator 117 (e.g., a spring), and be configured to selectively position the reflector 112 in either a primary position or a secondary position. The latching device 115 may initially maintain the reflector 112 in the primary position, e.g., by locking the reflector 112 in the primary position. In response to receiving a trigger signal, the latching device 115 may release the reflector 112, thereby allowing the actuator 117 to move the reflector 112 from the primary position to the secondary position. When the reflector 112 reaches the secondary position, the latching device 115 may lock the reflector 112 in place, e.g., by latching the reflector 112 in the secondary position. The reflector 112 may remain in this position until the positioning device 114 is reset to the primary position, e.g., manually by a field operative, through remote actuation of a solenoid, or by any other suitable means.

FIG. 4A depicts the optical switch 100 in a primary state during which the reflector 112 is positioned in a primary position that is outside the paths of both optical beams 70c, 70d. While the network access point 14 is in this primary or normal state, the optical beam 70c emitted/received by the primary common port 62 is provided to/received from the filters 68, and the optical beam 70d emitted/received by the secondary common port 63 is provided to/received from the secondary auxiliary port 104. Thus, in the normal state, the primary common port 62 is operatively coupled to the drop cables 28, and the secondary common port 63 is operatively coupled to the secondary auxiliary port 104. Advantageously, this configuration may enable the secondary distribution cable 22 to carry low priority traffic between the central office and one or more network nodes operatively coupled to the secondary auxiliary port 104.

FIG. 4B depicts the optical switch 100 in a secondary state during which the reflector 112 is in a secondary position that is in the path of each optical beam 70a, 70b. When the network access point 14 is in this secondary or protection state, the optical beam 70c emitted/received by the primary common port 62 is provided to/received from the primary auxiliary port 102, and the optical beam 70d emitted/received by the secondary common port 63 is provided to/received from the filters 68. Thus, in the protection state, the secondary common port 63 is operatively coupled to the drop cables 28, and the primary common port 62 is operatively coupled to the primary auxiliary port 102. While the optical switch 100 is in the secondary state, any low priority traffic carried by the secondary distribution cable 22 may be dropped so that the secondary distribution cable 22 can be used to provide a protection path between the central office and the network access device 14.

Although FIGS. 3A-4B depict the WDM device of the network access point 14 as being a free-space compact module, the WDM device could also be implemented as a planar-waveguide device (e.g., using silicon photonics) with MEMS actuators or ring resonators having thermo-optic or electro-optic tuners, or using any other suitable technology.

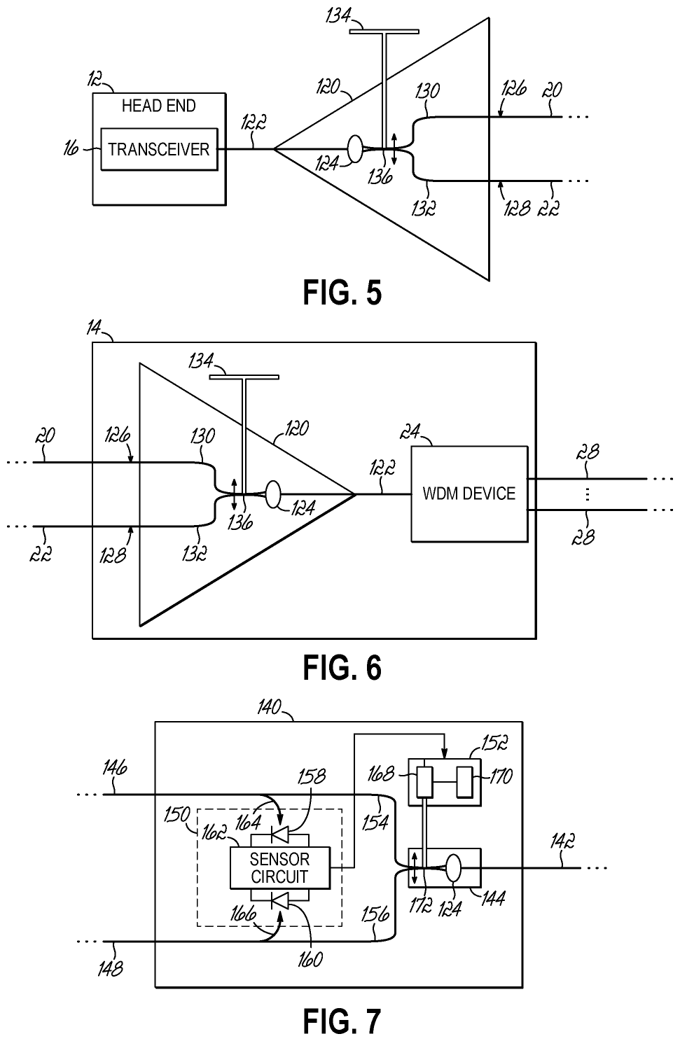

FIG. 5 depicts an exemplary optical coupling device 120 comprising a variable ratio coupler. The depicted variable ratio architecture may be used, for example, in the optical coupling device 26 in FIGS. 1A-1C, for the beam splitter 46 of FIG. 1B, or for the optical switch 52 of FIG. 1C. The optical coupling device 120 includes a common port 122 that is operatively coupled to an optical splitter 124, a primary branch port 126, a secondary branch port 128, an upper optical waveguide 130, a lower optical waveguide 132, and a controller 134. The optical splitter 124 may comprise a planar light-wave circuit, multi-clad coupler, or any other suitable type of optical splitter. The optical splitter 124 may be configured to split an optical beam entering the common port 122 into upper and lower optical beams that are provided to the upper and lower optical waveguides 130, 132, respectively. The controller 134 may be configured to adjust a physical relationship between the upper and lower optical waveguides 130, 132 (such as their relative position and/or shape) in a coupling region 136. For example, the controller 134 may bend, deflect, or change the geometry of the upper and lower optical waveguides 130, 132. Changes in this physical relationship between the upper and lower optical waveguides 130, 132 may, in turn, alter how an optical beam received at the common port 122 is proportioned between the primary and secondary branch ports 126, 128. Thus, the controller 134 may provide a mechanism for selecting an optical output power ratio between the primary and secondary branch ports 126, 128.

The optical coupling device 120 may be operated as a beam splitter 46 (FIG. 1B) by adjusting the power ratio so that the power level of the optical beams emitted by the primary and secondary branch ports 126, 128 has a ratio of about 1:1. That is, so that the power in each port is about 50% of the power at the common port 122.

The optical coupling device 120 may also be operated as an optical switch 52 (FIG. 1C) by adjusting the power ratio so that the power level of the optical beams emitted by the primary and secondary branch ports 126, 128 has an uneven split. For example, when used as a switch, the optical coupling device 120 may have a split such that the power in the active port contains at least a certain percentage (e.g., 80%) of the power at the common port 122, or has at least a minimum ratio of the power (e.g., ≥4:1) as compared to the inactive port.

FIG. 6 depicts the exemplary optical coupling device 120 as it may be used in the network access point 14. By reversing the coupler port configuration (swapping inputs and outputs) the optical coupling device 120 may operate as an optical selector switch. In this configuration, the controller 134 of optical coupling device 120 may be used to adjust the coupling ratio so that the optical coupling device 120 is in either a full cross-coupling mode or full bar coupling mode. In this way, the optical coupling device 120 may be used as an optical switch with two inputs.

The primary branch port 126 of optical coupling device 120 may be operatively coupled to the primary distribution cable 20, the secondary branch port 128 may be operatively coupled to the secondary distribution cable 22, and the common port 122 may be operatively coupled to the WDM device 24. Incorporating a variable ratio coupler operable as a 1×2 or 2×2 switch into the network access point 14 may enable a switching operation using the optical ports of the variable ratio coupler as a path selection switch. Thus, the optical coupling device 120 may be operated as an optical switch (e.g., for the protection schemes 10, 40 depicted by FIGS. 1A and 1B) or as a beam splitter (e.g., for protection scheme 50 depicted by FIG. 1C) depending on the type of protection scheme being implemented.

FIG. 7 depicts another exemplary optical coupling device 140 that may be used as an optical switch. The optical coupling device 140 includes a common port 142 operatively coupled to an optical splitter 144, a primary branch port 146, a secondary branch port 148, a sensing device 150, an actuator 152, an upper optical waveguide 154, and lower optical waveguide 156. The optical splitter 144 may comprise a variable rate/multiclad coupler-based optical switch (depicted), a latching MEMS switch, selectable position prism or mirror, a beam splitter, or any other suitable device. The advantages of the depicted type of optical coupler may include high reliability, broad optical bandwidth, spectrally flat optical transmission, and low transmission loss, e.g., ˜0.1 dB loss over the operating band. Low loss optical couplers may be used to avoid introducing optical impairments that could affect traffic.

The sensing device 150 may include a primary monitoring device 158, a secondary monitoring device 160, and a sensor circuit 162. Each of the monitoring devices 158, 160 may include a photodetector or other suitable light-sensitive device that is operatively coupled to a respective branch port 146, 148 by a respective tap line 164, 166. Each tap line 164, 166 may couple a portion (e.g., 1%) of an optical beam received by its respective branch port 146, 148 to its corresponding monitoring device 158, 160. The sensor circuit 162 may be configured to receive signals from the monitoring devices 158, 160 and determine whether to operatively couple the common port 142 to the primary branch port 146 or the secondary branch port 148 based on the received signals.

The actuator 152 may include a transducer 168 (e.g., a coupler, solenoid, electric motor, etc.) and an energy storage device 170, and may be configured to adjust the physical relationship between the primary and secondary waveguides 154, 156 in a coupling region 172 between one of two states, similar to the optical coupling device 120 (FIGS. 5 and 6). The actuator 152 may thereby switch the coupling of the common port 142 between the primary and secondary branch ports 146, 148. The energy storage device 170 may store energy chemically (e.g., in a battery), mechanically (e.g., in an elastic device, compressed gas, levitated mass, etc.), or electrically (e.g., in a capacitor). The energy stored by the energy storage device 170 may be used to move the transducer 168 in response to receiving a trigger signal from the sensing device 150. Energy may be pre-loaded into the energy storage device 170 by the manufacturer or when the network access point 14 is reset by a field operative. Energy may also be accumulated in the energy storage device 170 over time from the environment, e.g., using photovoltaic cells, from wind, vibrations, etc. Energy may also be accumulated from the optical signal itself. For example, in operation, at least one of the power monitors 158, 160 may be receiving power tapped from the upstream signal, and this power may be used to charge the energy storage device 170.

The actuator 152 may comprise an electro-mechanical mechanism that is pre-loaded to ensure rapid and reliable switching. For embodiments in which the actuator 152 is preloaded, the preloading may put the actuator 152 in a state such that the optical coupling device 140 operatively couples the primary branch port 146 to the common port 142. This may be considered a normal state during which the primary path is active. Network access points 14 may be shipped and installed in the normal state so that the drop cables 28 are initially operatively coupled to the primary path between the network access point 14 and head-end node 12.

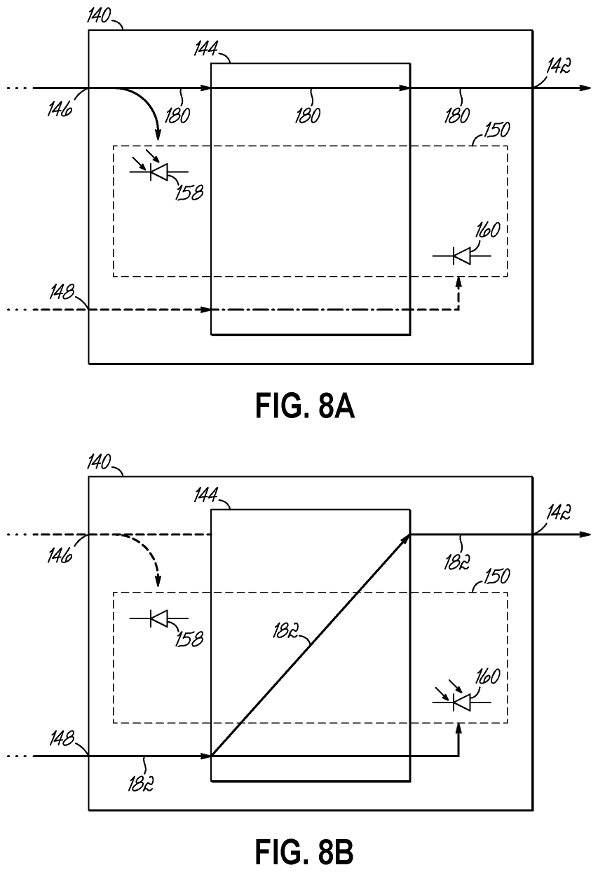

FIG. 8A depicts the optical coupling device 140 in a normal state during which a primary optical beam 180 is being received at the primary branch port 146 of optical coupling device 140, and no optical beams are being received at the secondary branch port 148 of optical coupling device 140. In this state, a portion of the primary optical beam 180 is received by the primary monitoring device 158 (e.g., causing a logic “1” state at the output thereof), and little or no light is received by the secondary monitoring device 160 (e.g., causing a logic “0” state at the output thereof). In response to receiving the outputs of the monitoring devices 158, 160 indicating the normal state, the sensing device 150 may cause the optical splitter 144 to couple the primary branch port 146 to the common port 142 so that the primary optical beam 180 is transmitted from the common port 142, e.g., to the WDM device 24. While in the normal state, an optical beam (not shown) received at the common port 142 (e.g., from the WDM device 24) may be transmitted from the primary branch port 148 toward the source of the primary optical beam 180.

FIG. 8B depicts the optical coupling device 140 in a protection state during which a secondary optical beam 182 is being received at the secondary branch port 148 of optical coupling device 140, and no optical beams are being received at the primary branch port 146 of optical coupling device 140. While in the protection state, a portion of the secondary optical beam 182 is received by the secondary monitoring device 160 (e.g., causing a logic “1” state at the output thereof), and little or no light is received by the primary monitoring device 158 (e.g., causing a logic “0” state at the output thereof). In response to receiving the outputs of the monitoring devices 158, 160 indicating operation of the network in the protection state, the sensing device 150 may cause the optical splitter 144 to couple the secondary branch port 148 to the common port 142 so that the secondary optical beam 182 is transmitted from the common port 142, e.g., to the WDM device 24. While in the protection state, an optical beam (not shown) received at the common port 142 (e.g., from the WDM device 24) may be transmitted from the secondary branch port 148 toward the source of the secondary optical beam 182.

In response to a protection event (e.g., an event that breaks the primary path or otherwise causes a persistent loss of signal which could result in a loss of data), the optical coupling device 140 may be triggered to connect the protection path to the WDM device 24. The optical coupling device 140 may be triggered automatically based on the output of the sensing device 150 integrated in the optical coupling device 140, or by an external signal received from a signaling system. The optical coupling device 140 may be triggered by a low energy transducer 168 powered by an energy storage device 170 including a long-life battery (e.g., 20 year battery), a wound spring, or any other device that can release sufficient energy to displace a keeper (e.g., a ball or shim). Displacing the keeper may allow the transducer 168 to relax into a switched state that causes the optical coupling device 140 to operatively couple the common port 142 to the protection path. In any case, the energy storage device 170 may only need to store sufficient energy to enable monitoring of received optical beams on the primary and secondary distribution cables 20, 22 periodically (e.g., once a second, a minute, or an hour) and sufficient to activate the transducer 168, which should occur infrequently.

Once the optical coupling device 140 is triggered, the network access point 14 may remain in the protection state until a truck rolls to restore the primary path, e.g., through repair as a result of intervention by a field operative. Once the repair has been made, the transducer 168 may be reset and the energy storage device 170 restored manually by the field operative, e.g., by inductively recharging the battery or supercapacitor, resetting the mechanical spring, etc. In an alternative embodiment, the network access point 14 may be configured to enable the optical coupling device 140 to be reset to the normal state remotely via a signaling system so that it is ready for another protection event without the need for a visit by the field operative.

A simple optical detection system may be incorporated into the network access point 14 in order to automatically switch the WDM device 24 from the primary path to the secondary path in the event of a failure in the primary path. A simple, reliable optical power detector with a response time in the millisecond range may be incorporated into the optical path using a very low ratio tap coupler, e.g., −20 dB coupling between the monitored optical waveguide and the tap port. A photodetector receiving light from the tap port may be operatively coupled to a control circuit designed to operate with extremely low power consumption. This may allow operation of the control circuit over a long period of time, e.g., 10 to 20 years. In an alternative embodiment of the network access point 14, a photodetector and controller may only be operatively coupled to the primary path such that a loss of signal on the primary distribution cable 20 triggers the network access point 14 to switch to the secondary distribution cable 22 without regard to the presence or absence of an optical beam on the secondary distribution cable 22.

The sensor circuit 162 may be configured to sample the output of the primary monitoring device 158 intermittently or continuously. In response to the optical signal detected by the primary monitoring device 158 falling below a predetermined threshold P_{T1}, the sensing circuit 162 may sample the output of the secondary monitoring device 160. If the optical signal detected by the secondary monitoring device 160 is above a predetermined threshold P_{T2}, the sensing circuit 162 may trigger the actuator 152 to switch the optical coupling device 140 from the normal state to the protection state. Thus, the above described embodiment of the sensing circuit 162 may only trigger the optical switch to implement the protection state if both the primary optical beam 180 is below a predetermined loss of signal threshold and the secondary optical beam 182 is above a predetermined presence of signal threshold.

The transducer 168 may be configured so that after the actuator 152 is triggered to implement the protection state, the actuator 152 remains locked in place, e.g., by a latching device. The transducer 168 may be configured to remain in this locked state until intervention by a field operative resets the actuator 152, e.g., by recharging the battery and/or resetting the trigger mechanism. This type of latching behavior may be referred to as non-revertive operation. Optical coupling devices 140 including this feature may be referred to as non-revertive optical switches. When operated as a non-revertive optical switch, the optical coupling device 140 cannot autonomously switch back to the normal state, but rather requires intervention. Use of non-revertive optical switches may be advantageous in certain situations because they do not require system-level intervention to operate. Advantageously, this feature may enable deployment of network access points 14 without the effort and complexity of providing systems-level intervention.

In cases where electrical power is available either locally or remotely, the signaling, detection, controlling, triggering, and resetting functions may be powered using external electrical power. Electrical power may be provided, for example, by a local utility power source or through a hybrid cable containing both an optical fiber and electrical conductors that carry power from a remote source.

In another embodiment, the network access point 14 may include a plurality of optical coupling devices 26 to enable full duplex operation. Full duplex operation may also be achieved using layered WDM demultiplexing technology. Having a plurality of optical coupling devices 26 may also enable optical switch functions (e.g., 1:N or N:1) that can be used to provide a WDM-based channel selector. As a WDM selector switch, this may provide automation of the specific WDM channel that is connected to the end user/end point. Cascading optical switches based on variable ratio optical couplers may enable the system to be scaled in a tree-and-branch architecture that extends a 1:2 optical switching function to 1:4, 1:8, etc.

In another embodiment, power-consuming elements of the network access point 14 may be provided with power using a remote optical power scheme. To this end, the head-end node 12 may include an optical source such as a high-power laser or transceiver. The optical source may transmit light at a wavelength corresponding to the telemetry band (1620 to 1650 nm), or some other suitable wavelength that does not interfere with optical signals carrying data. This out-of-band light may be received at the network access point 14 and converted to electrical energy to provide remote power. The out-of-band light may be routed into the optical distribution network and demultiplexed at the switch, where an energy harvesting system can convert the out-of-band light into electrical power. This electrical power may be used, for example, to charge a battery or ultracapacitor. The stored electrical energy may then be used to power selected components if and when a protection event occurs that requires switching to a protection path.

In another embodiment, a temporary latching effect may be achieved for a time sufficient to repair the optical network using a battery as the energy storage device. In this embodiment, the primary and secondary optical paths may be monitored. In response to detecting a protection event, a control device in the network access point may activate a low-energy optical switch, such as a MEMS optical switch. Because the low-energy optical switch requires little power, the battery may be capable of maintaining the network access point in the protection state for a sufficient amount of time to repair the primary path, e.g., several days. Once the repair has been made, the controller may cause the optical switch to revert to normal operation in response to receiving confirmation that the primary path has been restored. After restoration of the primary path, the battery can be recharged.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. A network access point, comprising:
a first common port configured to receive a primary optical beam including a plurality of primary optical signals;
a second common port configured to receive a secondary optical beam including a plurality of secondary optical signals;
a wavelength division multiplexing device including a plurality of channel ports each configured to transmit a respective optical signal of a selected one of the plurality of primary optical signals or the plurality of secondary optical signals; and
an optical coupling device configured to operatively couple at least one of the primary optical beam and the secondary optical beam to the wavelength division multiplexing device.

2. The network access point of claim 1, wherein:
the optical coupling device includes a beam splitter configured to split each of the primary optical beam and the secondary optical beam into a first portion thereof and a second portion thereof, and
the first portion of each of the primary optical beam and the secondary optical beam is provided to the wavelength division multiplexing device.

3. The network access point of claim 2, further comprising:
a tap port, wherein the second portion of each of the primary optical beam and the secondary optical beam is provided to the tap port.

4. The network access point of claim 2, wherein the beam splitter is further configured to:
split an uplink optical beam into a first portion thereof and a second portion thereof;
provide the first portion of the uplink optical beam to the first common port; and
provide the second portion the uplink optical beam to the second common port.

5. The network access point of claim 1, wherein:
the optical coupling device includes an optical switch having a first switch state and a second switch state,
while in the first switch state, the optical switch operatively couples the first common port to the wavelength division multiplexing device and optically isolates the second common port from the wavelength division multiplexing device, and
while in the second switch state, the optical switch operatively couples the second common port to the wavelength division multiplexing device and optically isolates the first common port from the wavelength division multiplexing device.

6. The network access point of claim 5, further comprising:
an actuator configured to switch the optical switch from the first switch state to the second switch state in response to receiving a trigger signal, and
a sensing device configured to generate the trigger signal in response to detecting one or both of a loss of signal at the first common port and a presence of signal on the second common port.

7. The network access point of claim 6, wherein:
the sensing device is further configured to detect a presence of signal at the first common port, and
the actuator is further configured to cause the optical coupling device to operatively couple the wavelength division multiplexing device to the first common port in response to the sensing device detecting the presence of signal at the first common port.

8. The network access point of claim 6, wherein the actuator includes:
a first actuator state that causes the optical switch to be in the first switch state,
a second actuator state that causes the optical switch to be in the second switch state, and
a latching device configured to maintain the actuator in the first actuator state until the trigger signal is received from the sensing device.

9. The network access point of claim 8, wherein the latching device is further configured to:
release the actuator in response to receiving the trigger signal while the actuator is in the first actuator state, and
in response to the actuator entering the second actuator state, maintain the actuator in the second actuator state until the actuator is reset.

10. The network access point of claim 5, further comprising:
a first auxiliary port, wherein the optical switch is further configured to operatively couple the first auxiliary port to the second common port while in the first switch state.

11. The network access point of claim 10, further comprising:
a second auxiliary port, wherein the optical switch is further configured to operatively couple the second auxiliary port to the first common port while in the second switch state.

12. A method of increasing availability in an optical network, comprising:
transmitting a primary optical beam including a plurality of primary optical signals over a primary distribution cable to a first common port of a network access point;
splitting, at the network access point, the primary optical beam into a first portion thereof and a second portion thereof;
providing the first portion of the primary optical beam to a wavelength division multiplexing device of the network access point; and
in response to detecting a problem in the primary distribution cable:
stop transmitting the primary optical beam over the primary distribution cable, and
begin transmitting a secondary optical beam including a plurality of secondary optical signals over a secondary distribution cable to a second common port of the network access point;
splitting, at the network access point, the secondary optical beam into a first portion thereof and a second portion thereof; and
providing the first portion of the secondary optical beam to the wavelength division multiplexing device of the network access point.

13. The method of claim 12, further comprising:
providing the second portion of the primary optical beam or the second portion of the secondary optical beam to a tap port of the network access point.

14. The method of claim 12, further comprising:
splitting, at the network access point, an uplink optical beam into a first portion thereof and a second portion thereof;
providing the first portion of the uplink optical beam to the first common port; and
providing the second portion the uplink optical beam to the second common port.

15. A method of increasing service availability in an optical network, comprising:
transmitting a primary optical beam including a plurality of primary optical signals over a primary distribution cable to a first common port of a network access point;
transmitting a secondary optical beam including a plurality of secondary optical signals over a secondary distribution cable to a second common port of the network access point;
operatively coupling the primary optical beam from the first common port of the network access point to a wavelength division multiplexing device of the network access point;
in response to detecting a problem in the primary distribution cable, operatively coupling the secondary optical beam from the second common port of the network access point to the wavelength division multiplexing device of the network access point.

16. The method of claim 15, wherein the secondary optical beam is transmitted over the secondary distribution cable in response to detecting the problem with the primary distribution cable.

17. The method of claim 15, wherein the problem in the primary distribution cable is detected based at least in part on a loss of signal at the first common port of the network access point.

18. The method of claim 15, wherein the problem in the primary distribution cable is detected based at least in part on a presence of signal at the second common port of the network access point.

19. The method of claim 15, further comprising:
in response to detecting a presence of signal at the first common port of the network access point while the second common port is operatively coupled to the wavelength division multiplexing device, optically coupling the first common port to the wavelength division multiplexing device and optically isolating the second common port from the wavelength division multiplexing device.

20. The method of claim 15, further comprising:
while the primary optical beam is operatively coupled from the first common port to the wavelength division multiplexing device, operatively coupling the second common port to a first auxiliary port, and
in response to detecting the problem in the primary distribution cable, operatively coupling the first common port to a second auxiliary port of the network access point.
